(19) United States
(12) Patent Application Publication
(10) Pub. No.: US 2002/0005458 A1
(43) Pub. Date: Jan. 17, 2002

(54) Airfoil suitable for forward and reverse flow

(76) Inventors: Jay W. Carter JR., Burkburnett, TX (US); John G. Roncz, Elkhart, IN (US)

Correspondence Address: James E. Bradley, Bracewell & Patterson, L.L.P., PO Box 61389, Houston, TX, 77208-1389, US

(21) Appl. No.: 09/877,268

(22) Filed: Jun. 8, 2001

Related U.S. Application Data
(60) Provisional application No. 60/210,394, filed on Jun. 9, 2000.

(51) Int. Cl. B64C 3/00

(52) U.S. Cl. 244/35 R

(57) ABSTRACT

An airfoil has a concave rear top surface, a concave rear bottom surface, and a rounded trailing edge to increase the lift-to-drag ratio of the airfoil at small angles of attack when air is flowing from the trailing edge to the leading edge (reverse flow), while maintaining a high lift-to-drag ratio when air is flowing from the leading edge to the trailing edge (forward flow). The airfoil design results from a performance compromise between forward and reverse airflow. For structural reasons, the thickness of the airfoil in proportion to its chord length may change along the blade radius. Thus, a family of airfoils has been designed that promote low-drag laminar flow with both forward and reverse flow, permit operation of the airfoil with reverse flow over a reasonable range of angles of attack, and achieve high lift with forward flow.

This application claims the benefit of U.S. Provisional Application No. 60/210,394 filed Jun. 9, 2000.

### BACKGROUND OF THE INVENTION

1. Field of the Invention

This invention relates to an airfoil family for the rotor of a high-speed autogyro aircraft, and more particularly to an airfoil family that increases the lift-to-drag ratio of the airfoil at small angles of attack when air is flowing from the trailing edge to the leading edge (reverse flow), while maintaining a high lift-to-drag ratio when air is flowing from the leading edge to the trailing edge (forward flow).

2. Description of Prior Art

A high-speed rotorcraft, such as shown in U.S. Pat. No. 5,727,754, is hereinafter referred to as a gyroplane. A gyroplane achieves high speed by reducing the rate of rotation of the rotor blade to reduce its drag, while a wing provides most of the lift required to maintain flight. The rate of rotation of the rotor blade must be reduced at high aircraft forward speeds to keep the blade that is rotating forward toward the direction of travel (the advancing blade) below the speed of sound. However, reducing the rotor rotation rate also reduces the airspeed of the blade that is rotating backwards away from the direction of travel (the retreating blade). When the aircraft forward speed to rotor tip rotational speed ratio (known as mu) is 1.0, the retreating blade tip has zero airspeed and air is flowing backwards over the remainder of the retreating blade. In flight, at higher mu ratios, the entire retreating blade is in reverse flow. Therefore, the lift and drag of the rotor blade is strongly affected by its airfoil characteristics in reverse flow.

The mu ratio never exceeds approximately 0.5 in helicopters because the rotor in those aircraft must always provide at least enough lift to keep the aircraft airborne. Since the lift moment of the advancing blade must always equal the lift moment of the retreating blade, the retreating blade must always provide approximately half the lift. At a mu ratio of 0.5, the inner half of the retreating blade has a low airspeed and high angle of attack, so it is stalled and provides little lift. Only the other half of the retreating blade is providing lift. At higher speeds, the portion of the retreating blade that provides lift decreases, setting an upper limit to the forward speed of helicopters. Since helicopters can never exceed a mu of 1.0, the prior art of rotor airfoil profile design has focused on the performance of the airfoil in forward flow at various angles of attack, and on reducing the pitching moment to reduce collective control forces. No designers have previously seen the need for a compromise between airfoil profile performance in forward flow and airfoil profile performance in reverse flow.

### SUMMARY OF THE INVENTION

The present invention uses an innovative design to produce an airfoil comprising a concave rear top surface, a concave rear bottom surface, and a rounded trailing edge to increase the lift-to-drag ratio of the airfoil at small angles of attack when air is flowing from the trailing edge to the leading edge (reverse flow), while maintaining a high lift-to-drag ratio when air is flowing from the leading edge to the trailing edge (forward flow). The airfoil design results from a performance compromise between forward and reverse airflow. For structural reasons, the thickness of the airfoil in proportion to its chord length may change along the blade radius. Thus, a family of airfoils has been designed that promote low-drag laminar flow with both forward and reverse flow, permit operation of the airfoil with reverse flow over a reasonable range of angles of attack, and achieve high lift with forward flow.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is a side view of a prior art airfoil.

FIG. 2 is an enlarged side view of the trailing portion of the airfoil of FIG. 1, modified to have a rounded trailing edge.

FIG. 3 is a side view of an airfoil constructed in accordance with the present invention.

FIG. 4 is an enlarged side view of the trailing portion of the airfoil of FIG. 3.

FIG. 5 is a graph of the lift-to-drag ratio versus the coefficient of lift for forward flow for the airfoils of FIGS. 1 and 3.

FIG. 6 is a graph of the drag coefficient for reverse flow of the airfoils of FIGS. 1 and 3, at various angles of attack and Reynolds numbers.

### DETAILED DESCRIPTION

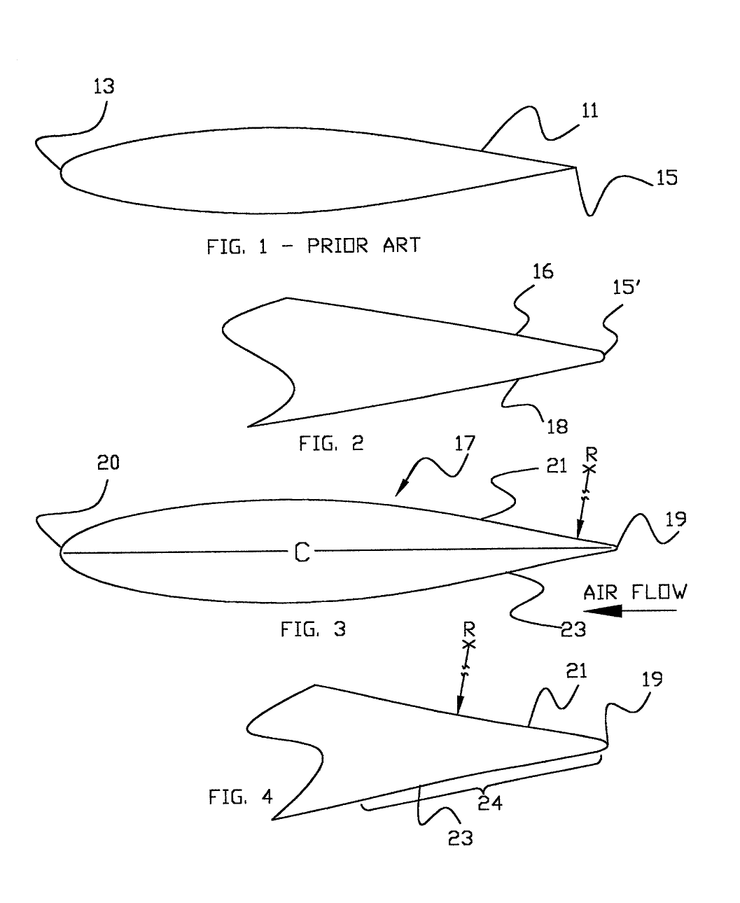

Referring to FIG. 1, conventional airfoil 11 is a type specified as NACA 65012, having a rounded leading edge 13 and a sharp trailing edge 15. The rounded leading edge 13 permits operation over a large range of angles of attack. The sharp trailing edge 15 reduces drag by smoothly merging the flow along the top of the airfoil with the flow along the bottom. The top and bottom surfaces of airfoil 11 are convex, specifically those portions 16, 18 immediately forward of trailing edge 15.

In a high-speed gyroplane, trailing edge 15, or at least a portion thereof, must, during a portion of a rotation cycle, act as a leading edge when the forward speed of the gyroplane exceeds the rotational speed of certain sections of the rotor. It is well known that sharp leading edges promote stalling of the airfoil at very small angles of attack. Many airplanes exploit that phenomenon by incorporating sharp triangular appendages to the leading edge of a wing over a small portion of the wingspan to force the stall to occur prematurely over a small section of the wing. This device is called a “stall strip” or “stall bar”. By forcing the wing to stall over a small percentage of the wingspan, the stalling behavior of the entire wing can be made more gentle.

Since the airfoil of the present invention must operate over a range of angles of attack when the flow is reversed, a sharp trailing edge is not desirable because the airfoil would stall and create high drag. Therefore, the trailing edge must be rounded. However, if trailing edge 15 of airfoil 11 were simply cut off and rounded to form trailing edge 15′, as shown in FIG. 2, the air in forward flow would not flow smoothly around the rounded trailing edge 15′. Instead, the streamlines would separate from the airfoil surface near trailing edge 15′ and cause increased drag. The drag due to streamline separation is primarily caused by pressure drag. Pressure drag results from low pressure air pulling on an aft-facing surface. Drag slows the high-speed gyroplane down and is generally undesirable.

FIG. 3 shows an airfoil 17 constructed in accordance with the present invention. Airfoil 17 has been designed to minimize pressure drag in forward flow while maintaining a rounded trailing edge 19 for better performance in reverse flow. The radius of curvature of trailing edge 19 is much smaller than the radius of curvature of leading edge 20. Concave surfaces 21, 23 (FIG. 4) formed in the rear portion of the top and bottom surfaces, respectively, of airfoil 17, decelerate the air to a much slower velocity than conventional airfoil 11 with convex surfaces 16, 18. In forward flow, when the flow separates near trailing edge 19, the streamline separation does not contribute as much to pressure drag because concave surfaces 21, 23 have increased the pressure in the trailing edge area to a level higher than ambient pressure. Concave surfaces 21, 23 are very shallow, thus are slightly exaggerated in FIG. 4.

Preferably concave surfaces 21, 23 are symmetrical, both being formed at a radius R that is greater than the chord C of airfoil 17 from leading edge 20 to trailing edge 19. Concave surfaces 21, 23 extend from a point aft of the midpoint of chord C substantially to trailing edge 19, as indicated by numeral 24 in FIG. 4. Also, concave surfaces 21, 23 are located aft of the thickest part of airfoil 17, which is approximately at the midpoint of chord C in this embodiment. Concave surfaces 21, 23 preferably extend the full length of airfoil 17, from each tip to a center of axis of rotation. Although shown formed with a single radius, concave surfaces 21, 23 could be compound curves.

Rounded trailing edge 19 improves the range of angles of attack for which airfoil 17 provides lift in reverse flow. Having a larger rounded trailing edge 19 increases the range of angles of attack for low drag in reverse flow, while slightly increasing drag in forward flow when used in conjunction with slight concave depressions 21, 23. A rounded trailing edge 19 having an elliptical shape, for example, is an effective compromise between preventing flow separation at trailing edge 19 during forward flow and providing lift when trailing edge 19 encounters reverse flow. Airfoil section 19 also facilitates low drag operation, whether the flow is forward or reverse, by promoting laminar flow.

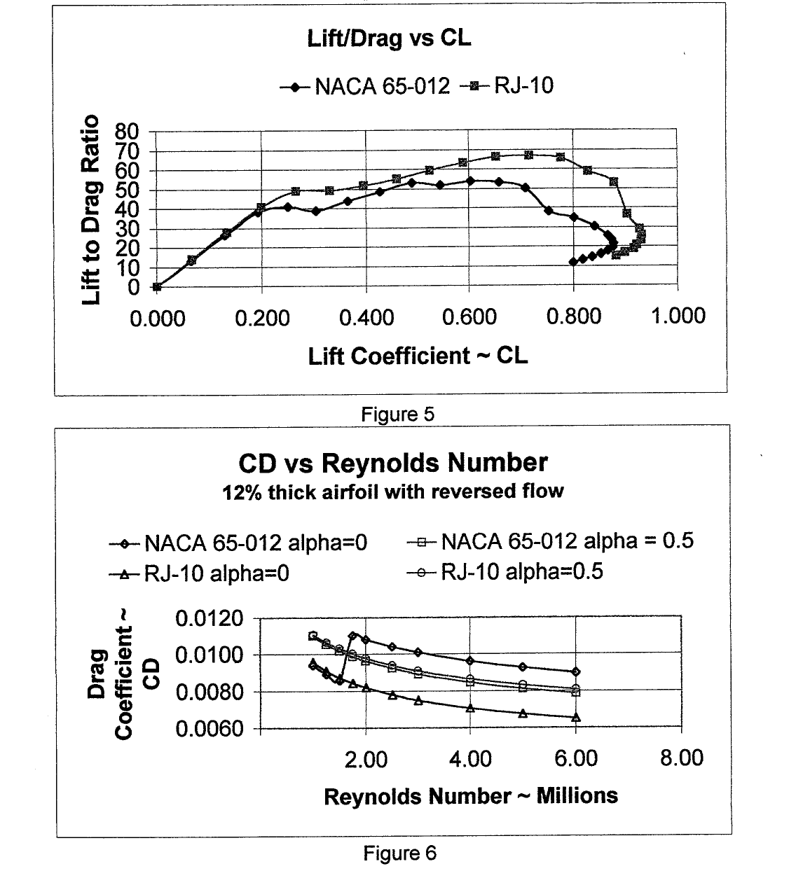

FIG. 5 graphs the lift-to-drag ratio versus the lift coefficient in forward flow of the prior art airfoil 11 and airfoil 17 of the present invention. Airfoil 11 has the designation NACA 65-012 while airfoil 17 has the designation RJ-10. Airfoil 17 has a peak lift-to-drag ratio of 67, higher than the corresponding peak for airfoil 11.

FIG. 6 graphs the drag coefficient versus the Reynolds number for two different angles of attack (alpha) in reverse flow for airfoils 11 and 17. At very small angles of attack, airfoils 11 and 17 have very similar drag coefficients, but as the angle of attack increases, airfoil 17 has a much lower drag coefficient in a large range of Reynolds numbers because it is not stalled. FIGS. 5 and 6 illustrate that airfoil 17 performs better in forward and reverse flow than prior art airfoil 11.

Laminar flow, which has approximately one-tenth the drag of turbulent flow, is maintained by gradually increasing the local velocity along the surface of airfoil 17. By making airfoil 17 thicker, one can accelerate the air along the surface of airfoil 17. The problem is decelerating the flow gradually. An area of low pressure will form just aft of the thickest portion of airfoil 17, where the air has been accelerated the most. To avoid the pressure drag associated with rounded trailing edge 19, the flow must be decelerated until the pressure near the trailing edge is higher than ambient pressure. Airfoil 17 must control the rate of deceleration very carefully to avoid the tendency of the air, given this pressure distribution, to flow from trailing edge 19 toward the thickest portion of the airfoil, causing a massive loss of lift and increase in drag. Those skilled in the art of airfoil design will be familiar with techniques for maintaining laminar flow.

When the flow is reversed, round leading edge 20 becomes the trailing edge. The reverse flowing air will not be able to “stick” to airfoil 17 in this region, causing pressure drag. To reduce the pressure drag in reverse flow, it would be desirable to make leading edge 20 (in forward flow) sharper. However this would limit the range of useable angles of operation in forward flow, and would reduce maximum lift. Therefore the shape of leading edge 20 is a compromise to achieve the needed lift in conventional operation while avoiding excessive pressure drag in reverse flow.

The present invention offers many advantages over the prior art. The rounded trailing edge allows for better lift-to-drag performance during reverse airflow. In that situation, the rounded edge helps to avoid stalling. The concave depressions in the top and bottom surfaces help prevent pressure drag by reducing the speed of the air flowing across the airfoil (in forward flow) just prior to reaching the trailing edge, and thus increasing the pressure in the void immediately behind the trailing edge. The rounded trailing edge compensates for reverse airflow problems, but causes deteriorated performance during forward flow. The depressions compensate for the reduced performance introduced by the rounded trailing edge during forward flow so that the overall airfoil performance throughout a complete rotation cycle during high-speed flight is better than prior art airfoils. The thicker, rounded trailing edge also sustains less structural damage due to rain, hail, sand, or stones that may be sucked into the plane of the rotor during operations than a conventional thin, sharp trailing edge.

While the invention has been particularly shown and described with reference to a preferred and alternative embodiments, it will be understood by those skilled in the art that various changes in form and detail may be made therein without departing from the spirit and scope of the invention.

What is claimed is:

1. An airfoil for use as a rotor on aircraft comprising:
a body having a top surface and a bottom surface;
a leading edge on a forward portion of the body formed by the intersection of a forward portion of the top surface and a forward portion of the bottom surface;
a trailing edge on a rearward portion of the body formed by the intersection of a rearward portion of the top surface and a rearward portion of the bottom surface;
a depression in the top surface near the trailing edge; and
a depression in the bottom surface near the trailing edge.

2. The airfoil of claim 1 in which the leading edge is rounded.

3. The airfoil of claim 1 in which the trailing edge is rounded.

4. The airfoil of claim 1 in which the trailing edge is elliptical.

5. The airfoil of claim 1 in which:
the leading edge is rounded, having a first radius of curvature;
the trailing edge is rounded, having a second radius of curvature; and
the first radius of curvature is greater than the second radius of curvature.

6. The airfoil of claim 1 in which the depressions are symmetrical.

7. The airfoil of claim 1 in which each depression is formed at a radius of curvature greater than a chord of the airfoil.

8. The airfoil of claim 1 in which each depression is located between a thickest portion of the airfoil and the trailing edge.

9. An airfoil for use as a rotor on an aircraft comprising:
a body of variable thickness having a top surface and a bottom surface;
a rounded leading edge on a forward portion of the body formed by the intersection of a forward portion of the top surface and a forward portion of the bottom surface, the rounded leading edge having a first radius of curvature;
a rounded trailing edge on a rearward portion of the body formed by the intersection of a rearward portion of the top surface and a rearward portion of the bottom surface, the rounded trailing edge having a second radius of curvature that is smaller than the first radius of curvature;
the body increasing in thickness from the leading edge to an area of maximum thickness between the top surface and the bottom surface, then decreasing in thickness to the trailing edge;
a depression in the top surface between the area of maximum thickness and the trailing edge; and
a depression in the bottom surface between the area of maximum thickness and the trailing edge.

10. The airfoil of claim 8 in which the depressions in the top and bottom surfaces have radii greater than a chord of the airfoil.

11. The airfoil of claim 8 in which the depressions are symmetrical.

12. A method of operating an airfoil on an aircraft, comprising the steps of:
providing an airfoil having a body of variable thickness as measured between a top surface and a bottom surface, a rounded leading edge on a forward portion of the body having a first radius of curvature, a rounded trailing edge on a rearward portion of the body having a second radius of curvature that is smaller than the first radius of curvature, the body having an area of maximum thickness between the leading edge and the trailing edge, a depression in the top surface between the area of maximum thickness and the trailing edge, and a depression in the bottom surface between the area of maximum thickness and the trailing edge;
rotating the airfoil and moving the aircraft forward, defining an advancing blade portion and a retreating blade portion;
reducing the speed of air flowing across the advancing blade portion in the depressions, increasing the pressure in a void immediately behind the trailing edge; and
increasing the speed of the aircraft such that air flows in reverse over substantially all of the retreating blade portion.
